(19) United States
(12) Patent Application Publication
(10) Pub. No.: US 2011/0032711 A1
(43) Pub. Date: Feb. 10, 2011

(54) HIGH EFFICIENCY PROJECTION SYSTEM

(75) Inventors: Swen-Uwe Baacke, Neuburg/Donau (DE); Gerhard Loeffler, Eichstaett (DE); Dirk Rosenthal, Gaimersheim (DE); Wolfgang Seitz, Eichstaett (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/935,912

(22) PCT Filed: Apr. 2, 2008
(86) PCT No.: PCT/EP08/53906

§ 371 Date: Oct. 1, 2010

(51) Int. Cl. F21V 7/08; H01J 5/08; F21V 7/00; H01J 9/00

(52) U.S. Cl. 362/297; 313/110; 362/296.01; 445/58

(57) ABSTRACT

A lamp may include a lamp bulb made from glass for accommodating an anode and a cathode, which has a fill gas wherein the lamp bulb has, at least partially, an antireflective coating.

Lamp, lamp module and projector with said lamp module

### TECHNICAL FIELD

The invention relates to a lamp, in particular a short-arc discharge lamp for a lamp module for projectors with a lamp bulb consisting of glass, in particular quartz glass, for accommodating an anode and a cathode, which has a fill gas, in particular xenon.

### PRIOR ART

In conventional projectors, a lamp, in particular a xenon short-arc high-pressure discharge lamp, is inserted into a housing with a reflector system, which has a light exit opening closed by a cover disk. Such a lamp or such a lamp module is known from document WO 2006/07228.

One problem with these projectors is that a plurality of transitions between optically different media, in particular air or fill gas−quartz glass/glass, need to take place in the beam path of the light from the light source (arc high-pressure discharge lamp) up to the exit window of the light. As a result of these media transitions, reflection losses occur since some of the incident light does not enter the medium but is reflected thereby and therefore cannot be utilized by the system. Since there may be up to eight transitions between different media in conventional projectors, the resultant light losses add up to over 25 percent. Furthermore, the reflections in projection system result in thermal problems and undesirable parasitic light effects.

In order to compensate for the light losses, the prior art proposes using lamps with increased luminous efficacy, such as xenon short-arc high-pressure discharge lamps, for example. However, the increased lamp power also results in thermal problems, in addition to increased lamp costs and shorter lamp life, since, in addition, effective cooling of the lamps, the reflectors and the exit window needs to be provided.

### DESCRIPTION OF THE INVENTION

The invention is therefore based on the object of providing a lamp for a lamp module of a projector, such a lamp module, and such a projector as well as a method for manufacturing said lamp, which ensures a high luminous efficacy without making the lamp excessively expensive or without having to accept the mentioned disadvantage.

This object is achieved by a lamp and a lamp module for projectors with such a lamp, wherein the lamp has a lamp bulb consisting of glass, in particular quartz glass, for accommodating an anode and a cathode, wherein a fill gas, in particular xenon, is provided in the lamp bulb, and the lamp bulb has, at least partially, an antireflective coating on the inner and/or outer side.

Owing to the use of an antireflective coating on the boundary layers between the media, the reflection losses of the light are reduced. This improves the overall luminous efficacy of the system, with the result that it is also possible to use light sources with a lower power without reducing the luminous efficacy. As a result of the use of light sources with a lower power, the thermal problems are also reduced in the projector, with the result that more useful light is available given the same lamp power.

A particularly advantageous exemplary embodiment is one in which the lamp bulb has, at least partially, an antireflective coating both on the inner and on the outer side. This is advantageous if the lamp has been built into a lamp module for a projector with a reflector system, with it being particularly advantageous if the reflector system is formed by two reflectors, wherein the second reflector (auxiliary reflector) is a spherical reflector and the first reflector (main reflector) is an elliptical reflector. Since light which is incident on the auxiliary reflector is reflected back in the direction of the main reflector through the lamp bulb by virtue of the auxiliary and main reflectors being arranged correspondingly, the light is no longer reflected as it enters or passes through the lamp bulb as a result of the antireflective coating. Precisely in the case of these lamp modules it is possible for provision to be made for the lamp bulb to be coated on the inner and outer side in the region in which light is emitted to the auxiliary reflector, while the lamp bulb only has a coating on the inner side in the region in which light is only emitted to the main reflector.

In a further advantageous exemplary embodiment, the light exit opening of the auxiliary reflector is closed by a cover disk, which likewise has an antireflective coating owing to the reflections occurring thereon. The cover disk advantageously consists of a transparent glass ceramic or quartz glass, wherein glass ceramic is preferred owing to its good coating properties.

The design of the reflector system with a spherical and/or elliptical reflector ensures that light which is not emitted in the direction of the main reflector, and would therefore be lost, is reflected back onto the main reflector and, from there, can likewise emerge through the light exit opening covered by the cover disk.

A particularly advantageous exemplary embodiment is one in which the antireflective coating on the lamp bulb or exit window consists of a layer stack with different materials and layer thicknesses, wherein materials and layer thicknesses are geared to providing suppression which is as effective as possible of the reflection in the waveband of from 380 nm to 780 nm. SiO₂, TiO₂, Nb₂O₅, Ta₂O₅, MgF₂ and/or ZrO₂ are particularly advantageous.

Particularly preferred is a coating comprising a layer stack, in which ZrO₂ is applied, as first layer, to the lamp bulb or the exit window, wherein, subsequently, in each case one layer of MgF₂ and ZrO₂ and, as the final layer, a layer of MgF₂ are applied. The layer thicknesses and also the number of layers can vary, however.

Further advantages and advantageous embodiments are defined in the dependent claims and the figures of the description.

The invention will be described in more detail below with reference to drawings, wherein the exemplary embodiment shown in the figure is not intended to fix the scope of the patent application.

### BRIEF DESCRIPTION OF THE DRAWINGS

The invention will be explained in more detail below with reference to exemplary embodiments. In the drawings:

FIG. 1 shows a basic illustration of the reflection at the transition between two optically different media, and

FIG. 2 shows a side view of a lamp module according to the invention with exemplary radiation profiles.

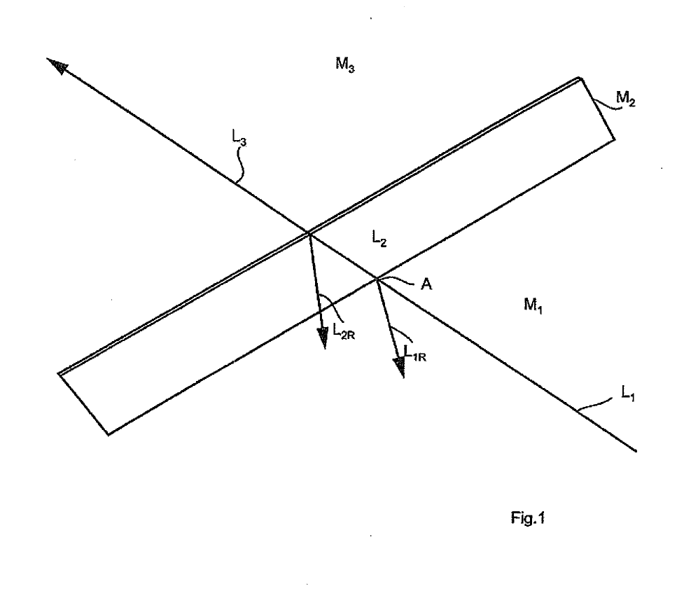

FIG. 1 shows a schematic of the basic problem of reflection at the transition between optically different media. A light beam L₁, which propagates in a first medium M₁ and is incident on a second, optically different medium M₂, for example a glass disk, is reflected with a low proportion as it is incident on the optically different medium M₂ and does not completely enter the optically different medium M₂. This is illustrated in FIG. 1, wherein the light beam L₁ is incident, schematically at point A, on the optically different medium M₂ and, for the most part, L₂ enter the different medium M₂, while some L_{1R} is reflected. As it emerges from the optical medium M₂, in turn some L_{2R} of the light beam L₂ is reflected, while the majority L₃ of the light beam L₂ enters into the optically different medium M₃ through the medium. Owing to these two reflections L_{1R} and L_{2R}, the intensity of the light beam L₃ in comparison with the light beam L₁ is markedly reduced.

By means of an antireflective coating according to the invention which is applied to the optically different medium M₂, the proportions of the reflected light L_{1R} and L_{2R} can be reduced to such an extent that they are no longer of any consequence, with the result that incident light beam L₁ and reflected light beam L₃ have substantially the same intensity.

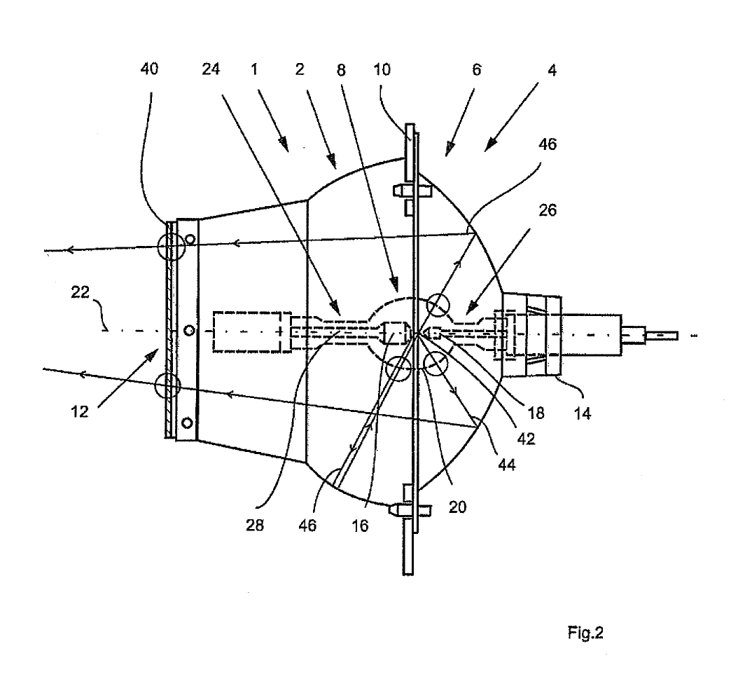

FIG. 2 shows a preferred embodiment of the invention. As shown in FIG. 2, the lamp module 1 according to the invention has a reflector system 6, which is formed by a first, spherical reflector 2 and a second, elliptical reflector 4 and in which a lamp 8 is accommodated. The lamp 8 is borne by the reflector system 6 and forms therewith a preassembled unit, which is inserted, in such a way as to be electrically insulated, in a wall 10 of a projector, for example a digital projector with LCD or DLP/DMD technology.

The spherical reflector 2 is formed by a light exit opening 12 and the elliptical reflector 4 is formed by a reflector neck 14, wherein the lamp 8 is mounted, in accordance with the invention, in the region of the reflector neck 14 and the light exit opening 12. The light exit opening 12 is closed by a cover disk 40 consisting of glass ceramic or quartz glass.

Owing to the development of heat of the lamp 8 and the associated restriction to the life, effective cooling is required. For this purpose, air can be blown into the reflector system 6 via a fan (not illustrated). The cooling air flow surrounds the lamp 8 and effectively prevents an accumulation of heat from being produced in the reflector system 6.

In the exemplary embodiment illustrated, the lamp 8 is in the form of a xenon short-arc high-pressure discharge lamp with a conventional design. Such a short-arc lamp substantially includes an anode 16, a cathode 18, which are each fitted on an electrode rod 28, and a lamp bulb 20 filled with a high-purity xenon gas. This lamp bulb 20 merges, along an optical axis 22, on both sides with in each case one approximately cylindrical lamp shaft 24, 26, into which the electrode rods 28 of the anode 16 and cathode 18, respectively, are fuse-sealed in a gas-tight manner.

The reflector system 6 consists of an electrically conductive material and is provided with a reflective coating. Owing to the use of the reflector system 6 as mechanical and electrical connecting element of the lamp 8 to the projector 10, the manufacturing complexity is substantially reduced in comparison with the prior art.

The spherical reflector 2 and the elliptical reflector 4 can be connected to one another via radially protruding plane faces, which together form a flange, along which the lamp module 1 is fastened, in the insulated fashion, on the projector 10.

According to the invention, the lamp bulb 20 has an antireflective coating on its inner side and on its outer side, with the result that light which is generated via an arc 42 generated between the electrodes 16 and 18 is not reflected as it passes through the optically different media, gas/glass/gas.

FIG. 2 shows a schematic illustration of a beam path of the light, wherein the beam 44 represents emission in the direction of the main reflector. This light beam 44 is reflected at the main reflector 4 and is reflected at the second focal point of the elliptical main reflector, namely an exit window of a projection system, not illustrated here. In this case, the light beam 44 likewise passes through the cover disk 40, wherein, in turn, there is a transition between optically different media.

According to the invention, therefore, the cover disk 40 can also have an antireflective coating, with the result that the reflections occurring here are likewise minimized.

The emitted light proportion 46 of the arc 42, which is not directly incident on the elliptical main reflector 4 but is reflected onto the main reflector 4 by means of the auxiliary reflector 2, does not pass through the lamp bulb 20 only once, but performs this transition three times. Firstly, the light beam 46 emerges from the lamp bulb 20, is then reflected back into its focal point, namely the arc 42, by the auxiliary reflector 2, wherein a further transition between air and glass is performed and then in turn emerges through the lamp bulb 20 in order to be reflected in the direction of the cover disk 40 by the main reflector 4. The transitions between optically different media are identified by circles in the figure.

Owing to the antireflective coating according to the invention, it is possible for radiation losses which are produced by the reflection at the transition between optically different media to be markedly reduced, wherein the antireflective coating preferably consists of a layer stack with layers of different thickness and of different materials. In this case, layer thickness and sequence are optimized to the extent that reflections in the visible range, i.e. between 380 nm and 780 nm are minimized.

Preferably, the materials SiO₂, TiO₂, Nb₂O₅, Ta₂O₅, MgF₂ and/or ZrO₂ are used.

These materials firstly demonstrate good adhesion and are secondly thermally stable, with the result that they can easily withstand the high temperatures arising during lamp operation. In a particularly preferred exemplary embodiment, the antireflective coating consists of a layer stack of four layers, wherein ZrO₂ is applied as first layer to the glass and then a layer of MgF₂, a further layer of ZrO₂ and a final layer of MgF₂ are applied. Particularly preferred in this exemplary embodiment is a layer thickness sequence of 18.65 nm (ZrO₂); 37.23 nm (MgF₂); 142.56 nm (ZrO₂) and 99.64 nm (MgF₂).

The layer thicknesses and sequences specified here can be varied as required and it is also possible for more or fewer layers to be used.

In addition, it is also possible to select single-layered antireflective coatings, wherein the material or the material composition can also be correspondingly adapted.

The invention discloses a lamp and a lamp module for a projector with such a lamp, wherein the lamp bulb and/or a cover disk of the lamp module has, at least partially, an antireflective coating (FIG. 2).

### LIST OF REFERENCE SYMBOLS

1 Lamp module
2 Reflector
4 Reflector
6 Reflector system
8 Lamp
10 Wall
12 Light exit opening
14 Reflector neck
16 Anode
18 Cathode
20 Lamp bulb
22 Axis
24 Lamp shaft
26 Lamp shaft
28 Electrode rod
40 Cover disk
42 Arc
44 Light beam
46 Light proportion

1. A lamp, comprising:
a lamp bulb made from glass for accommodating an anode and a cathode, which has a fill gas,
wherein the lamp bulb has, at least partially, an antireflective coating.

2. The lamp as claimed in claim 1, wherein the lamp bulb has the antireflective coating on at least one of its inner and outer side.

3. The lamp as claimed in claim 1,
wherein the antireflective coating is a layer stack comprising a plurality of layers applied one on top of the other.

4. The lamp as claimed in claim 3,
wherein the layers consist of a material selected from a group consisting of:
SiO₂; TiO₂; Nb₂O₅; Ta₂O₅; MgF₂; ZrO₂; and a combination or a mixture of one or more of the mentioned materials.

5. The lamp as claimed in claim 3,
wherein the layer thicknesses vary.

6. The lamp as claimed in claim 3,
wherein layer thicknesses and layer sequence are optimized for an antireflective coating in the spectral range of from 380 nm to 780 nm.

7. The lamp as claimed in claim 3,
wherein the antireflective coating is formed from an alternating layer sequence of ZrO₂ and MgF₂.

8. A lamp module for projectors, the lamp module comprising:
a reflector system with at least one reflector,
wherein a lamp is accommodated in the lamp module, the lamp comprising a lamp bulb made from glass for accommodating an anode and a cathode, which has a fill gas wherein the lamp bulb has, at least partially, an antireflective coating.

9. The lamp module as claimed in claim 8,
wherein the reflector system is formed with a light exit opening, which is closed by a cover disk.

10. The lamp module as claimed in claim 8,
wherein the cover disk has an antireflective coating.

11. The lamp module as claimed in claim 10,
wherein the antireflective coating is a layer stack comprising a plurality of layers applied one on top of the other.

12. The lamp module as claimed in claim 11,
wherein the layers consist of a material selected from a group consisting of:
SiO₂; TiO₂; Nb₂O₅; Ta₂O₅; MgF₂; ZrO₂; and a combination or a mixture of one or more of the mentioned materials.

13. The lamp module as claimed in claim 11,
wherein the layer thicknesses vary.

14. The lamp module as claimed in claim 11,
wherein layer thicknesses and layer sequence are optimized for an antireflective coating in the spectral range of from 380 nm to 780 nm.

15. The lamp module as claimed in claim 11,
wherein the antireflective coating is formed from an alternating layer sequence of ZrO₂ and MgF₂.

16. The lamp module as claimed in claim 9,
wherein the reflector system comprises two reflectors.

17. The lamp module as claimed in claim 16,
wherein the first reflector is elliptical and the second reflector is spherical.

18. The lamp module as claimed in claim 9,
wherein the at least one reflector consists of metal.

19. The lamp module as claimed in claim 9,
wherein the cover disk consists of glass ceramic.

20. A projector with a lamp module, the lamp module comprising:
a reflector system with at least one reflector,
wherein a lamp is accommodated in the lamp module, the lamp comprising a lamp bulb made from glass for accommodating an anode and a cathode, which has a fill gas wherein the lamp bulb has, at least partially, an antireflective coating.

21. A method for manufacturing a lamp, the method comprising:
providing lamp bulb; and
coating the lamp bulb with an antireflective coating.

22-32. (canceled)
